(19) United States
(12) Patent Application Publication
(10) Pub. No.: US 2009/0304845 A1
(43) Pub. Date: Dec. 10, 2009

(54) Demolding Mechanism of Mold

(75) Inventors: Chih-Yu Chen, Taipei Hsien (TW); Jian-Guang Huang, Taipei Hsien (TW); Chun-Yan Wu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/134,060

(22) Filed: Jun. 5, 2008

(51) Int. Cl. B28B 7/10

(52) U.S. Cl. 425/438

(57) ABSTRACT

A demolding mechanism of mold includes a male mold, a swingable block and an elastic element. The male mold defines a receiving groove therein. The swingable block mounted in the receiving groove of the male mold has a pressing arm and a shaping arm connected with the pressing arm. The shaping arm defines a shaping portion for shaping a part of a product to be molded in the mold. The elastic element is resiliently disposed between the bottom of the pressing arm of the swingable block and the male mold for causing the swingable block to swing, which makes the product be disengaged from the shaping portion of the swingable block.

### BACKGROUND OF THE INVENTION

1. Field of the Invention

The present invention relates to a mold, and more particularly to a demolding mechanism of a mold for disengaging a product from the mold.

2. The Related Art

In industry manufacture, more and more products are formed in molds. The mold generally includes a demolding mechanism for disengaging the product from the mold.

Referring to FIG. 6, a conventional demolding mechanism of a mold is shown. The demolding mechanism suitable for disengaging a product 16 with a cavity from the mold includes a slide 14, an angular pin 13 fixed on a cavity plate (not shown), and a spring 15 disposed at a side of the slide 14. So when the mold is closed, the angular pin 13 is inserted in the slide 14, which drives the slide 14 moving toward the spring 15 and the spring 15 being compressed to store elastic force. Then a part of the slide 14 protrudes in a mold housing where the product 16 is formed for shaping the cavity on the product 16. On the contrary, when the mold is opened, the angular pin 13 is drawn out from the slide 14, and the spring 15 releases the elastic force to drive the slide 14 moving toward the opposite direction. Then the slide 14 is removed from the product 16. An ejector pin (not shown) pushes the product 16 out of the mold.

However, this conventional demolding mechanism is suited only to a big mold for shaping a big product. In case the product is small, the slide 14 would correspondingly become small to shape a cavity on the small product. In this case, it is very difficult for a smaller slide 14 to have enough space to receive the angular pin 13, and accordingly the small product is hard to be disengaged from the slide 14. Therefore, an improved demolding mechanism is desired for solving the problem.

### SUMMARY OF THE INVENTION

Accordingly, an object of the present invention is to provide a demolding mechanism of mold for disengaging a product from the mold. The demolding mechanism includes a male mold, a swingable block and an elastic element. The male mold defines a receiving groove. The swingable block mounted in the receiving groove of the male mold has a pressing arm and a shaping arm connected with the pressing arm. The shaping arm defines a shaping portion for shaping a part of the product to be molded in the mold. The elastic element is resiliently disposed between the bottom of the pressing arm of the swingable block and the male mold for causing the swingable block to swing, which makes the product be disengaged from the shaping portion of the swingable block.

As described above, when the mold is closed, the product is shaped in the mold. The part of the product is shaped through the shaping portion of the swingable block. At the same time, the pressing arm of the swingable block is pressed so that the elastic element is compressed for storing elastic force. After the product is shaped completely, the mold is opened. The elastic element releases the elastic force to drive the swingable block swinging. Therefore, the product is disengaged from the shaping portion of the swingable block. The demolding mechanism of the present invention utilizes the elastic force of the elastic element to drive the swingable block swinging to disengage the product from the swingable block. The structure of the demolding mechanism is simple and compact. Thereby, the demolding mechanism is adapted for shaping a part of a small product and disengaging the small product from the demolding mechanism and the mold.

### BRIEF DESCRIPTION OF THE DRAWINGS

The present invention will be apparent to those skilled in the art by reading the following description of a preferred embodiment thereof, with reference to the accompanying drawings, in which:

FIG. 1 is a schematic sectional view of a demolding mechanism of a mold of the present invention;

FIG. 2 partially shows a perspective view of a male mold in which the demolding mechanism shown in FIG. 1 is assembled;

FIG. 3 is an exploded view of the male mold and the demolding mechanism shown in FIG. 2;

FIG. 4 is a perspective view of a swingable block of the demolding mechanism of FIG. 1;

FIG. 5 is another perspective view of the swingable block of FIG. 4; and

FIG. 6 is a schematic view of a prior demolding mechanism of a mold.

### DETAILED DESCRIPTION OF THE PREFERRED EMBODIMENT

To facilitate understanding the invention, like components are designated by like reference numerals throughout a preferred embodiment of the present invention as shown in the attached drawings.

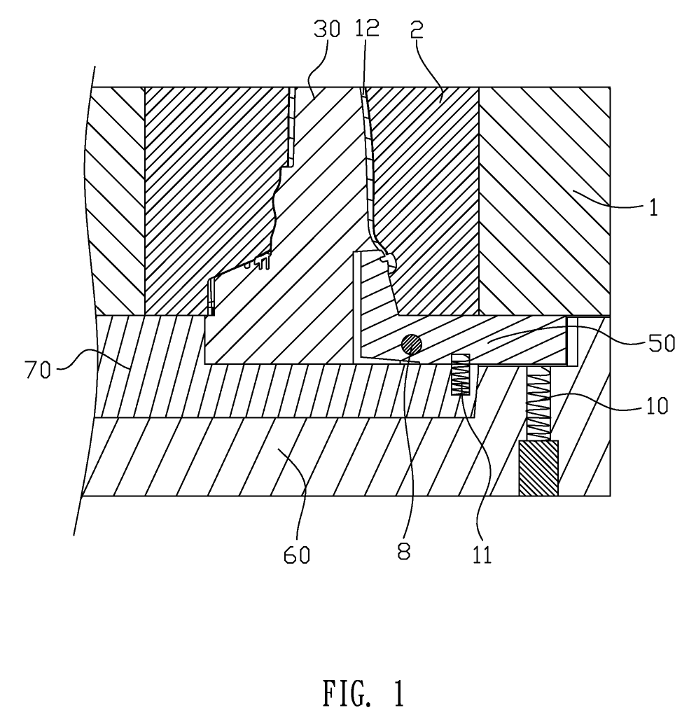

Referring to FIG. 1, a mold where a product 12 is plastic-molded includes a female mold and a male mold (not labeled). The female mold includes a cavity plate 1 and a cavity insert 2 located in the cavity plate 1. The male mold includes a core plate 60, a core insert 30 and a locating plate 70 for disposing the core insert 30. The cavity insert 2 and the core insert 30 define a mold housing to hold the product 12. A demolding mechanism assembled in the mold has two functions: one function is for shaping a part of the product 12 and the other function is for disengaging the product 12 from the mold.

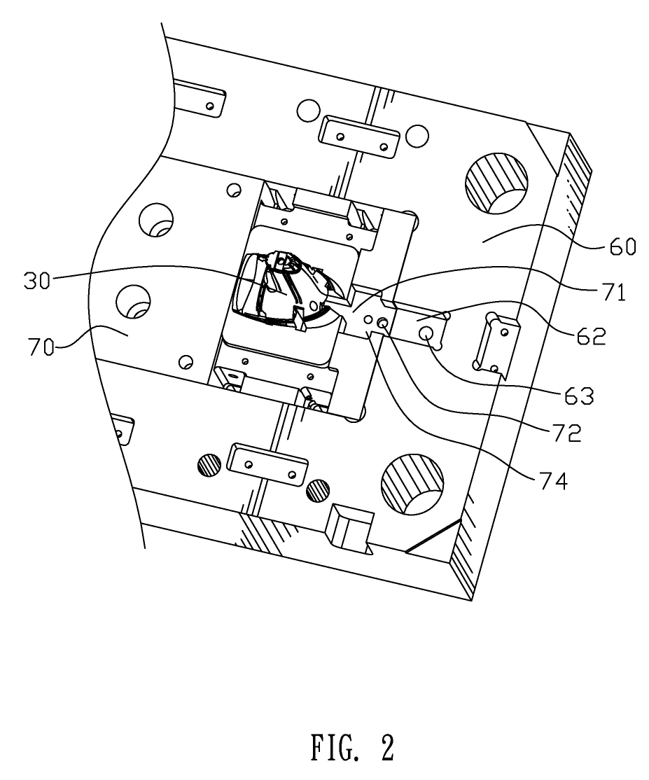

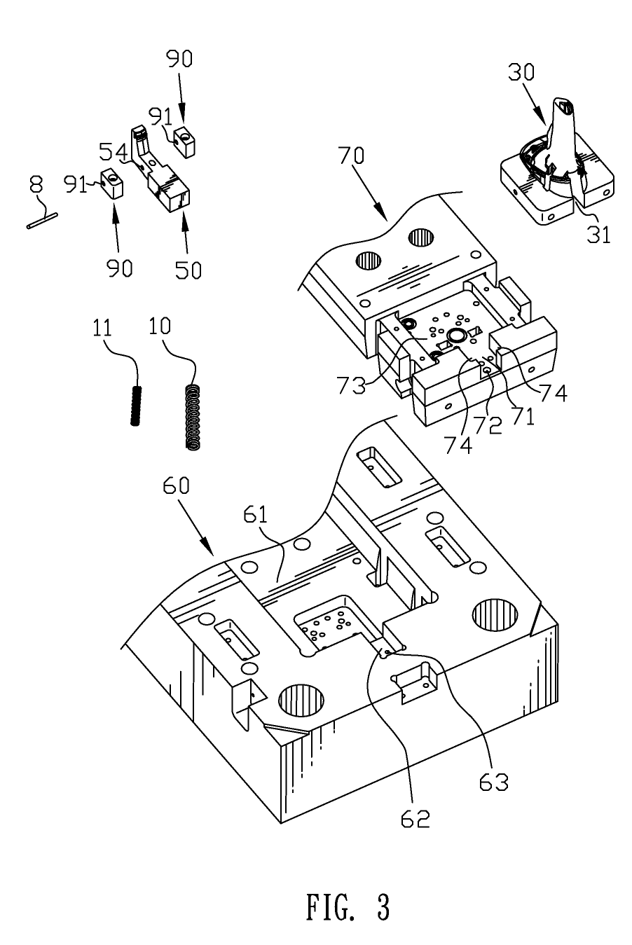

With reference to FIG. 2 and FIG. 3, the male mold is described in detail. The top of the core plate 60 defines a rectangular receiving recess 61 and a strip-shaped installing groove 62 communicating with the receiving recess 61. The bottom of the installing groove 62 defines a circular spring hole 63.

The locating plate 70 is rectangular in shape and mounted in the receiving recess 61 of the core plate 60. The top of the locating plate 70 defines a mounting recess 73 and a fixing groove 71 communicating with the mounting recess 73. The bottom of the fixing groove 71 and the bottom of the installing groove 62 of the core plate 60 are on the same plane. The bottom of the fixing groove 71 defines a first circular cave 72. The top of the locating plate 70 defines two auxiliary gaps 74 communicating with both the fixing groove 71 and the mounting recess 73 respectively.

The core insert 30 is disposed in the mounting recess 73 of the locating plate 70. The core insert 30 defines a slot 31 passing through a side thereof.

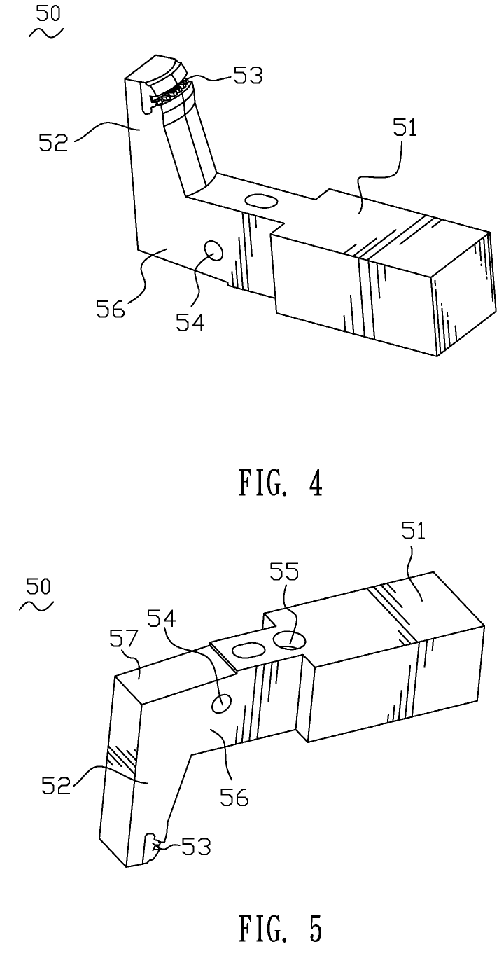

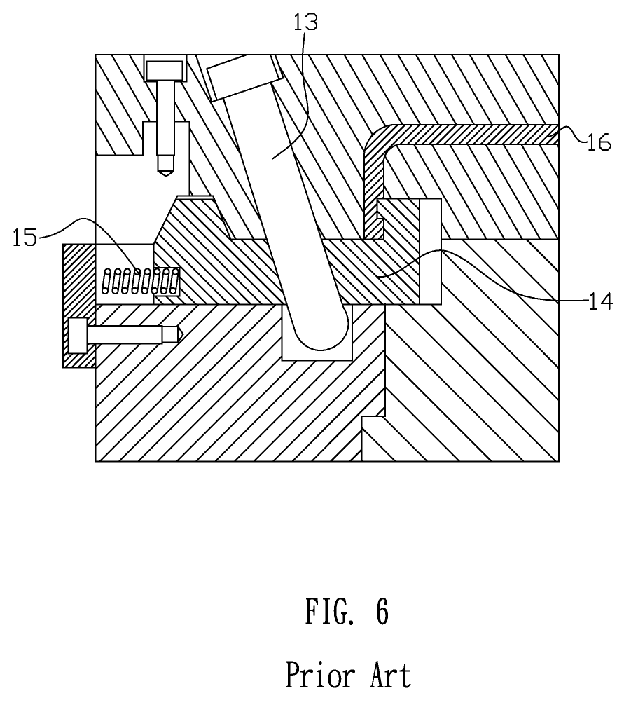

Referring to FIG. 3, FIG. 4 and FIG. 5, the demolding mechanism of the present invention includes a swingable block 50, two auxiliary blocks 90, a column-shaped pivot shaft 8, a primary spring 10 and an auxiliary spring 11. The swingable block 50 has a pressing arm 51 in rectangular strip-shape, a connecting arm 56 extending frontward from the center of the front of the pressing arm 51 and a shaping arm 52 extending upward from a free end of the connecting arm 56. A second circular cave 55 is defined at the bottom of the pressing arm 51 and adjacent to the bottom of the connecting arm 56. The connecting arm 56 defines a first running hole 54 passing through opposite sides thereof. The bottom of the connecting arm 56 defines an inclined surface 57 slanting upward and then extending through the front of the connecting arm 56. The top of the shaping arm 52 defines a shaping portion 53 at a rear surface thereof and facing the pressing arm 51.

The two auxiliary blocks 90 are disposed at the opposite sides of the connecting arm 56 of the swingable block 50. The auxiliary block 90 defines a second running hole 91 passing through opposite sides thereof. The pivot shaft 8 is inserted in the first running hole 54 and the second running holes 91 for assembling the auxiliary blocks 90 and the swingable block 50 together.

Referring to FIG. 1 and FIG. 3, when the demolding mechanism is assembled in the mold, the connecting arm 56 of the swingable block 50 is disposed in the front of the fixing groove 71 of the locating plate 70. The two auxiliary blocks 90 disposed at the opposite sides of the connecting arm 56 are respectively received in the two auxiliary gaps 74. The pressing arm 51 of the swingable block 50 is arranged in the rear of the fixing groove 71 and the installing groove 62 of the core plate 60. The primary spring 10 is located between the bottom of the pressing arm 51 of the swingable block 50 and the core plate 60. One end of the primary spring 10 is pressed against the bottom of the pressing arm 51 and the other end of the primary spring 10 is received in the spring hole 63. The auxiliary spring 11 is located between the bottom of the pressing arm 51 and the locating plate 70. An end of the auxiliary spring 11 is accommodated in the first circular cave 72 and an opposite end of the auxiliary spring 11 is accommodated in the second circular cave 55. The shaping arm 52 of the swingable block 50 is disposed in the slot 31 of the core insert 30, and moreover, a front surface of the shaping arm 52 and the core insert 30 keep a distance therebetween.

Please refer to FIG. 1 and FIG. 3 again. In use, when the mold is closed, the female mold and the male mold approach toward each other. The product 12 is shaped in the mold housing defined by the cavity insert 2 of the female mold and the core insert 30 of the male mold. A part of the product 12 is shaped through the shaping portion 53 of the shaping arm 52 disposed in the slot 31 of the core insert 30. At the same time, the pressing arm 51 of the swingable block 50 is pressed by the female mold so that the primary spring 10 and the auxiliary spring 11 are compressed for storing elastic force. After the product 12 is shaped completely, the mold is opened. The female mold and the male mold are separated apart from each other. The primary spring 10 and the auxiliary spring 11 release the elastic force to drive the swingable block 50 rotating widdershins around the pivot shaft 8. The inclined surface 57 of the swingable block 50 contacts the bottom of the fixing groove 71 of the locating plate 70. The front surface of the shaping arm 52 is against the core insert 30. Therefore, the product 12 is removed from the shaping portion 53 of the swingable block 50. At last, the product 12 is pushed out of the mold through ejector pins (not shown).

As described above, the demolding mechanism of the present invention utilizes the elastic force of the primary spring 10 and the auxiliary spring 11 to drive the swingable block 50 swinging to disengage the product 12 from the swingable block 50. The structure of the demolding mechanism is simple and compact. Thereby, the demolding mechanism is adapted for shaping a part of a small product and disengaging the small product from the demolding mechanism and the mold.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A demolding mechanism of mold, comprising:
a male mold defining a receiving groove;
a swingable block pivotally mounted in the receiving groove of the male mold, the swingable block having a pressing arm and a shaping arm connected with the pressing arm, the shaping arm defining a shaping portion for shaping a part of a product to be molded in the mold; and
an elastic element resiliently disposed between the bottom of the pressing arm of the swingable block and the male mold for causing the swingable block to swing, which makes the product be disengaged from the shaping portion of the swingable block.

2. The demolding mechanism of mold as claimed in claim 1, wherein the male mold includes a core plate, a locating plate mounted in the core plate and a core insert disposed in the locating plate, the core plate defines an installing groove, the locating plate defines a fixing groove, the bottom of the fixing groove and the bottom of the installing groove are on the same plane, the core insert defines a slot, the pressing arm of the swingable block is received in the installing groove and the fixing groove, the shaping arm is disposed in the slot of the core insert, and a front surface of the shaping arm and the core insert keep a distance therebetween.

3. The demolding mechanism of mold as claimed in claim 2, wherein the bottom of the installing groove defines a spring hole, a primary spring is located between the bottom of the pressing arm of the swingable block and the core plate, one end of the primary spring is pressed against the bottom of the pressing arm and the other end of the primary spring is received in the spring hole.

4. The demolding mechanism of mold as claimed in claim 2, wherein the bottom of the fixing groove defines a first cave, the bottom of the pressing arm defines a second cave, an auxiliary spring is located between the bottom of the pressing arm and the locating plate, an end of the auxiliary spring is accommodated in the first cave and an opposite end of the auxiliary spring is accommodated in the second cave.

5. The demolding mechanism of mold as claimed in claim 1, wherein the swingable block has a connecting arm extending frontward from the front of the pressing arm and the shaping arm extending upward from a free end of the connecting arm, the shaping portion being defined on the shaping arm faces the pressing arm.

6. The demolding mechanism of mold as claimed in claim 5, wherein the bottom of the connecting arm defines an inclined surface slanting upward and then extending through the front of the connecting arm.

7. The demolding mechanism of mold as claimed in claim 2, wherein the locating plate defines two auxiliary gaps connecting with opposite sides of the fixing groove, two auxiliary blocks are respectively disposed in the two auxiliary gaps, the swingable block defines a first running hole passing through opposites sides thereof, the auxiliary block defines a second running hole passing through opposite sides thereof, and a pivot shaft is inserted in the first running hole and the second running holes.
